(19) United States
(12) Patent Application Publication
(10) Pub. No.: US 2012/0003559 A1
(43) Pub. Date: Jan. 5, 2012

(54) FUEL GAS SUPPLY SYSTEM FOR A POWER-CONSUMING MEMBER, AND CONTROL MEMBER USABLE FOR SUCH A SYSTEM

(75) Inventors: Antoine Frenal, Ezanville (FR); Philippe Pisot, L'Isle Adam (FR)

(73) Assignee: L'Air Liquide Societe Anonyme pour L'Etude et I'Exploitation des Procedes Georges Claude, Paris (FR)

(21) Appl. No.: 13/201,843

(22) PCT Filed: Mar. 3, 2010
(86) PCT No.: PCT/FR2010/050358

§ 371 Date: Aug. 16, 2011

(30) Foreign Application Priority Data
Mar. 25, 2009 (FR) 0951932

(51) Int. Cl. F16K 31/04; H01M 8/04; F16K 31/46

(52) U.S. Cl. 429/444; 251/129.11; 251/129.12; 137/614.11

(57) ABSTRACT

The invention relates to a fuel gas supply system for a power-consuming member, particularly a gaseous hydrogen supply system for a fuel cell or a heat engine, the system including at least one upstream end comprising a movable mechanical actuator for selectively controlling the opening of an insulation valve of a pressurized fuel gas tank to be coupled to the at least one upstream end, the supply system including a member for controlling the movement of the mechanical actuator, characterized in that the control member is mechanically connected to the actuator via a selectively movable mechanical movement transmission member, the control member being offset relative to the actuator so as to remotely ensure the offsetting of the actuator via mechanical forces.

The present invention relates to a fuel gas supply system for a power-consuming member and a control member usable for such a system.

The invention relates, more particularly, to a fuel gas supply system for a power-consuming member, in particular a gaseous hydrogen supply system for a fuel cell or a heat engine, the system comprising at least one upstream end comprising a movable mechanical actuator for selectively controlling the opening of an isolating valve of a pressurized fuel gas tank designed to be coupled to the at least one upstream end, the supply system comprising a member for controlling the displacement of the mechanical actuator.

The invention relates, in particular, to the supply of devices consuming gas, for example a fuel cell or a heat engine for a vehicle, of which the fuel contains gaseous hydrogen stored in highly pressurized tanks (for example 700 bar and above). The invention relates, in particular, to refueling solutions, according to which the users replace empty tanks for full tanks. Naturally, the invention may also relate to applications where the tanks are fitted to the vehicle and fixed.

Regulations provide for the necessity of equipping the gaseous hydrogen tanks with isolating valves, the control of which being carried out in an entirely automated manner, permitting the closure of the supply system for the fuel cell or heat engine directly at the gas source. The use of hydrogen (or any other combustible gas) requires the components which comprise electromechanical actuators and which are located in the vicinity of the gas distribution system to meet the directives known as “ATEX” (“ATmospheres EXplosibles” (Explosive Atmospheres)). As a general rule, these regulatory specifications have a direct impact on the size of the components and pose technical problems when they have to be incorporated in small vehicles (two-wheeled vehicles, for example).

Respecting the “ATEX” directives also results in an increase in the cost of said components. The invention proposes a very safe technical solution which meets this regulatory restriction, in particular in the case where the refueling of a power-consuming member is carried out by replacing empty tanks by full tanks.

In the case of vehicles provided with fixed tanks installed in the vehicle, a high-pressure electromagnet, conforming to the ATEX directives, may be mounted directly at the tank outlet. This satisfies the requirement of having an automatic isolating device in the closest possible position to the gas source in the event of storage or malfunction of the gas distribution system, according to the requirements of the regulations. However, in certain applications, it is not advantageous or possible to provide fixed tanks and gas refueling at a service station (for example for wheelchairs propelled by a fuel gas) especially as the logistics of small canisters is relatively easy to provide.

An object of the present invention is to remedy all or some of the drawbacks of the prior art set forth above.

To this end, the gas supply system according to the invention, and according to the generic definition provided by the above preamble, is essentially characterized in that the control member is mechanically connected to the actuator via a selectively mobile mechanical movement transmission member, the control member being offset relative to the actuator so as to provide remotely the displacement of the actuator via mechanical forces.

The invention may also relate to the association of one or more systems for receiving gas, respectively connected to a removable pressurized gas tank. The invention relates, in particular, to a control system (via a control member) for systems receiving gas. The control member is thus displaced outside the (“ATEX”) danger zone and permits the opening of the gas distribution system in complete safety.

The invention may exhibit the following particularities or advantages.

The removable pressurized gas tank is provided with a gas distribution device. The gas distribution device comprises at least one gas isolating member such as a valve. For example, the gas distribution device is a tap or the equivalent mounted on and/or in the orifice of the tank. The isolating member is integrated in the valve and/or the supply system.

The supply system is preferably installed and fixed on-board the power-consuming member (the vehicle, for example). The supply system comprises an interface (upstream end(s)) capable of cooperating with the tank(s).

The control member remotely controls the opening of the isolating members (valves) of the gas distribution device via a mobile actuator.

The control member is preferably monostable, i.e. normally in a position which acts (or does not act) mechanically on the valve actuator so as to close said valve and isolate the gas distribution system of the canister. In this manner, the closure of the valve does not require the addition of external energy, in the event, for example, of current being disconnected from the system at an inopportune time.

The control member is preferably permanently supplied with electrical energy when the gas distribution system of one of the canisters is open. The architecture permits reduced energy consumption.

The control member is preferably provided with a device providing the command to an electronic control unit to stop the power-consuming member in the event of a detected abnormality, such as a rupture or mix-up of the cables for transmitting mechanical movement between the control member and the actuators.

The control member is preferably provided with a device for regulating the tension of the cable(s), making it possible not to use sensors (end of travel sensors, for example) inside the system. More specifically, said sensors are a potential source of energy (sparks) and incompatible with the (“ATEX”) safety directives.

Moreover, embodiments of the invention may comprise one or more of the following features:
the movement transmission member comprises a flexible cable and a mechanism for selective displacement of the cable or the rod,
the displacement mechanism is designed to provide selective traction of the cable to a mechanically unstable active position relative to a specific mechanically stable resting position, in its active position the cable being designed to arrange the actuator in a position controlling the opening of an isolating valve,
the cable is urged by default into its resting position by at least one return member or by mechanical inertia,
the displacement mechanism is electrically controlled and comprises an electric motor such as a geared motor providing selective traction of the cable to the active position, the displacement mechanism further comprising a device powered electrically for selectively retaining the cable in the active position and a commutator for deactivating the electrical supply to the electric motor to the benefit of the retaining device when the cable or the rod arrives in the active position,
the power or the electrical consumption of the retaining device is respectively less than the power or the electrical consumption of the electric motor,
the cable remains in its stable resting position or is displaced automatically into its stable resting position in the event of failure of the electrical supply to the displacement mechanism,
the device comprises two separate upstream ends, each comprising one respective mechanical actuator for opening an isolating valve of one respective gas tank, the control member controlling the displacement of the two actuators via respective transmission members,
the displacement mechanism comprises a single electric motor such as a geared motor, selectively providing traction of the respective transmission members to control the actuators so as to open independently the two valves (sequentially or simultaneously), the displacement mechanism also comprising two electrical or electromagnetic retaining devices, respectively associated with the two transmission members, the displacement mechanism also comprising one or more commutators to deactivate the power supply to the electric motor to the benefit of one or more retaining devices in order to retain the transmission member(s) in the active position.

At least one pressurized gas tank provided with an isolating valve is selectively connected or connectable to the upstream end of the system, the mechanical actuator selectively providing the opening of the isolating valve of the tank.

The invention also relates to a member for remotely controlling the displacement of one or two mechanical actuators, comprising an electrically controlled displacement mechanism, such as an electric motor or a geared motor, and one respective movement transmission member associated with each actuator, each transmission member having a first end connected to the displacement mechanism and a second end designed to be mechanically connected to one respective mechanical actuator for its displacement, the movement transmission member(s) comprising a flexible cable, the displacement mechanism being designed to provide selective traction of the transmission member(s) into a mechanically unstable active position relative to a specific mechanically stable resting position, each of the transmission member(s) being urged by default into its resting position, the displacement mechanism further comprising an electrically controlled device for retaining the transmission members in the active position, the displacement mechanism further comprising a commutator for deactivating the power supply to the electrically controlled displacement mechanism to the benefit of the retaining device(s), to retain the transmission member(s) in the active position.

The invention may also relate to any device or alternative method comprising any combination of the features set forth above or below.

According to further possible particularities taken separately or in combination:
the control member is permanently supplied with electrical energy when the system is supplied with fuel gas from a pressurized gas tank connected to an upstream end,
the control member is controlled by an electronic logic unit comprising, for example, an electronic board,
the control member is not provided with a position sensor to determine the position of the cable(s) (end of travel sensor, for example),
the cable(s) are mobile in respective sheaths mounted on a housing of the control member, the control member preferably also comprising a system for adjusting the length of the sheaths to adjust the tension or the length of the cable,
the control member comprises a device for adjusting the tension of the cable(s) in the sheath to preserve the mechanical integrity of the system by protecting it against any damage to the constituent elements in the event of excessive tractive forces,
the cable(s) are driven by the electric motor via a guide pulley system and/or articulated control cam(s),
each cable is associated with a tension limiter or displacement limiter to detect (via a switch or sensor) an excessive displacement of a mobile part (in particular a lever of the motor) and to control the stoppage of the motor in response to a detected excessive displacement,
the electrically powered device for retaining a transmission member in the active position comprises a conductive part fixed in translation to the transmission member and a electromagnet (or electromagnetic suction element) of which the electrical supply selectively causes the fixing of the plate to the fixed electromagnet,
the electric motor is stopped when the electrical current at its terminals exceeds a predetermined threshold,
the electromagnet (or electromagnetic suction element) is activated (powered electrically) when the specific threshold of electrical current at the terminals of the geared motor is exceeded (a commutation exists, therefore: the retaining in the active position is provided by the retaining device in place of the electric motor),
the displacements of the two movement transmission members are controlled by the same electric motor and are respectively implemented by movements (rotational movements, for example) in opposing directions,
the shaft of the motor is urged by default into its neutral position by at least one return member or by mechanical inertia when it is not subjected to current (stable neutral position not requiring electrical energy to be retained and unstable active position requiring electrical energy to be retained).

The invention also relates to the use of such a supply system or a member for remotely controlling the displacement of one or more mechanical actuators for the selective passage of fuel gas from a pressurized gas source to a member consuming said fuel gas, in particular for the supply of gaseous hydrogen to a fuel cell or heat engine.

Further particularities and advantages will appear from reading the following description made with reference to the figures, in which:

FIG. 1 shows a schematic partial view illustrating an example of the gas supply system according to the invention,

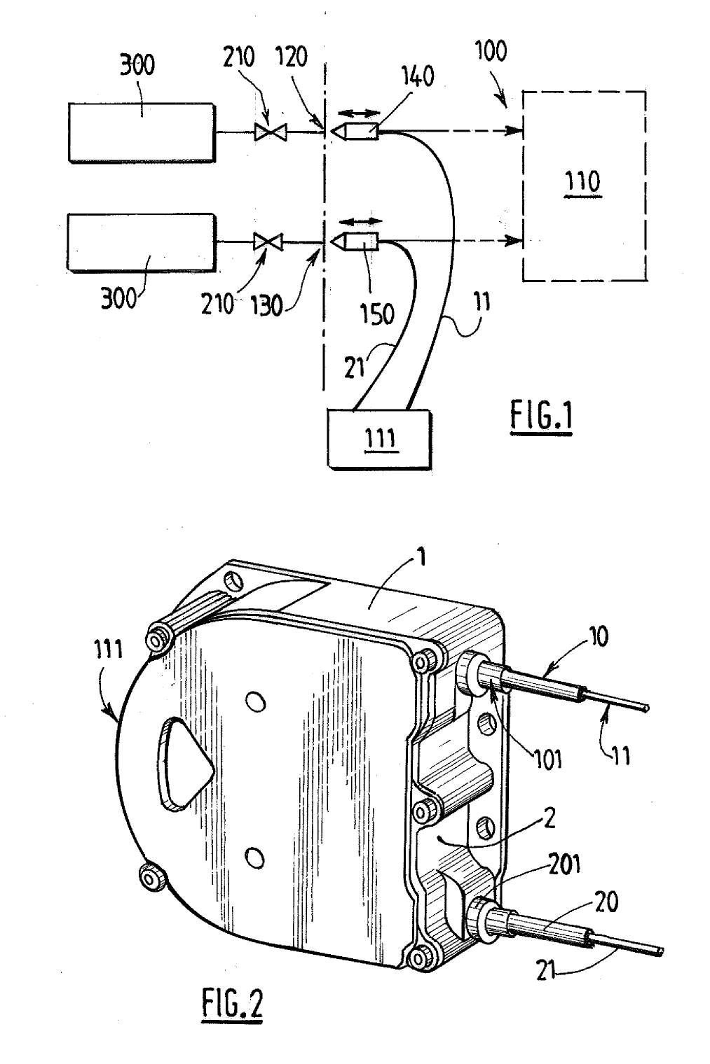

FIG. 2 shows an external view in perspective and from a first side of a possible embodiment of a control member according to the invention,

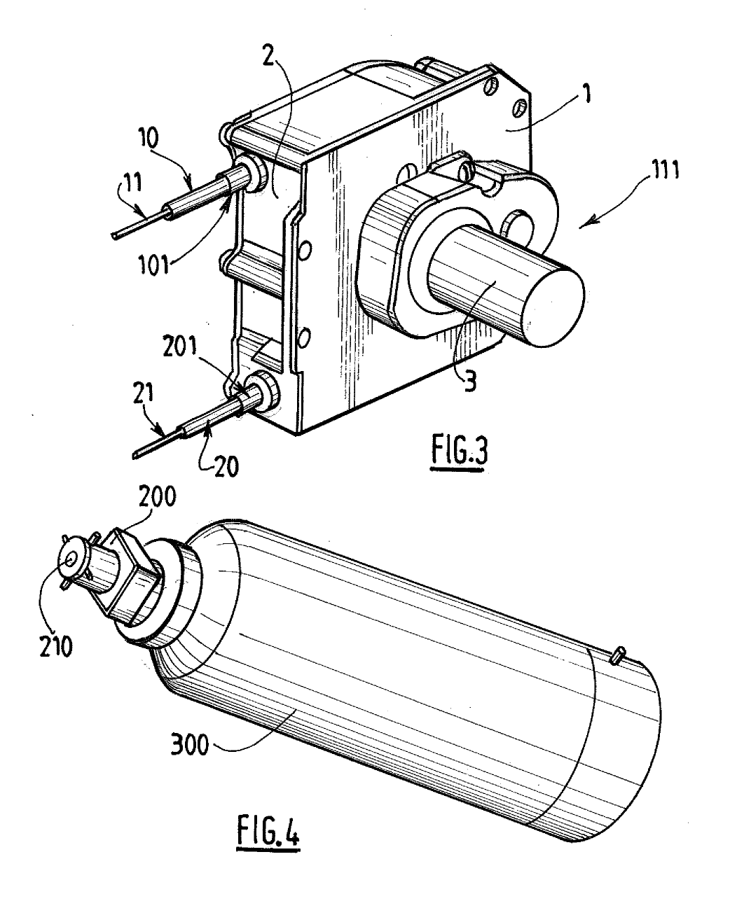

FIG. 3 shows an external view in perspective and from a second side of the control member of FIG. 2,

FIG. 4 shows an external view in perspective of an example of a tank equipped with a device for distributing gas, capable of being used in a system according to the invention,

FIG. 5 is an external view in perspective in which the control member of FIGS. 2 and 3 is connected to two connecting sleeves, each receiving a tank according to FIG. 4,

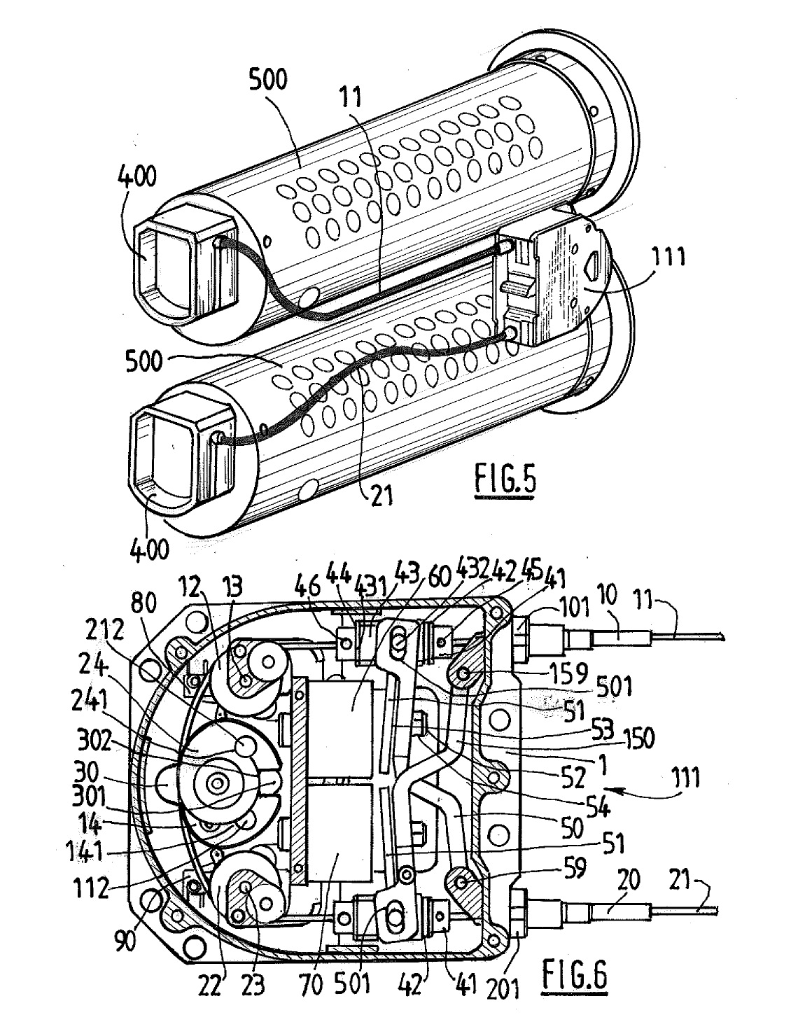

FIG. 6 shows a view in longitudinal section of the control member of FIGS. 2 and 3 in which the two transmission cables which it controls are in the resting position,

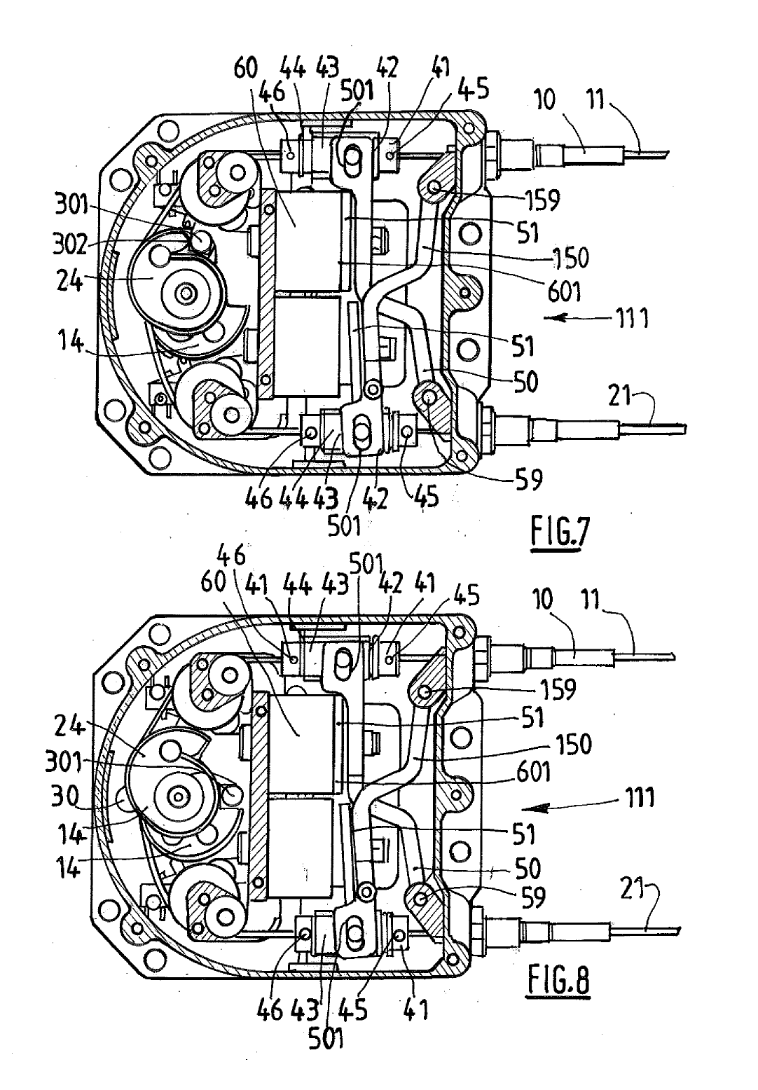

FIG. 7 shows a view in longitudinal section of the control member of FIGS. 2 and 3 in which the first transmission cable is in the active position (motor in the activated position) whilst the second cable is in the resting position,

FIG. 8 shows a view in longitudinal section of the control member of FIGS. 2 and 3 in which the first transmission cable is in the active position (motor in the neutral position) whilst the second cable is in the resting position,

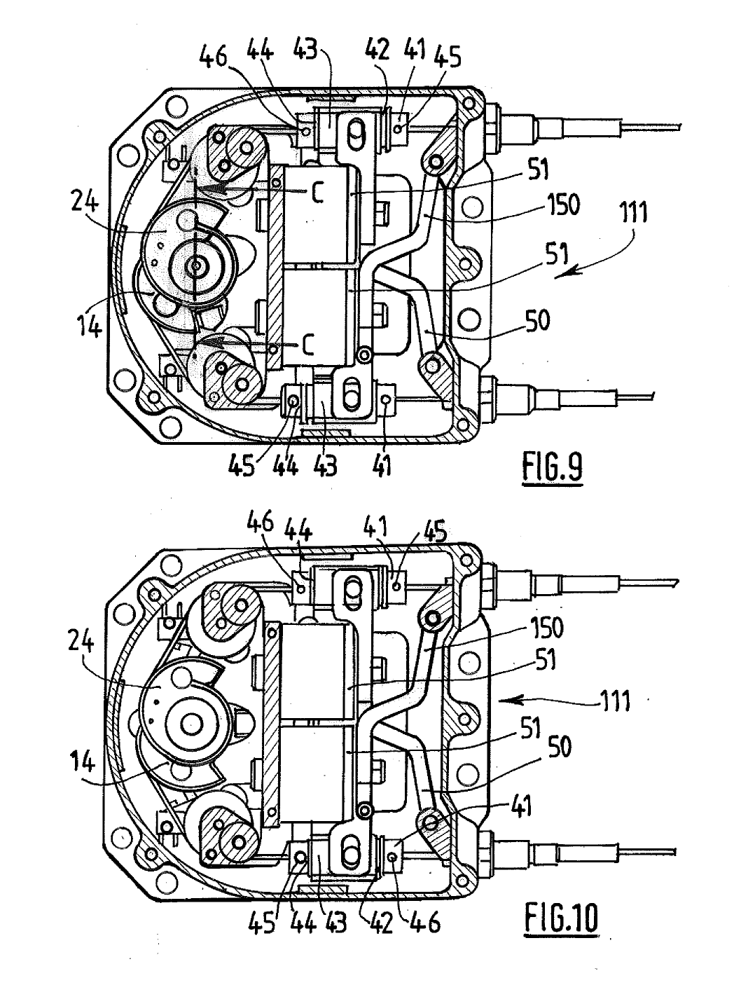

FIG. 9 shows a view in longitudinal section of the control member of FIGS. 2 and 3 in which the two transmission cables which it controls are in the activated position (motor in the active position),

FIG. 10 shows a view in longitudinal section of the control member of FIGS. 2 and 3 in which the two transmission cables which it controls are in the activated position (motor in the neutral position),

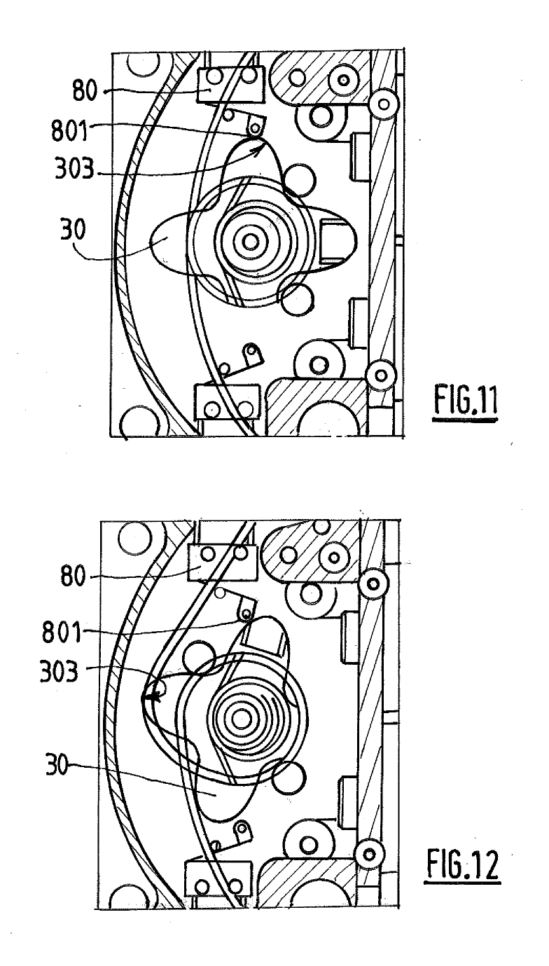

FIG. 11 is a view in detail of the embodiment of FIGS. 6 to 10, illustrating a control lever of the control mechanism in the neutral position,

FIG. 12 is a view in detail of the embodiment of FIGS. 6 to 10 illustrating the control lever of the control mechanism in the intermediate position (no contact between the lever and a micro-switch),

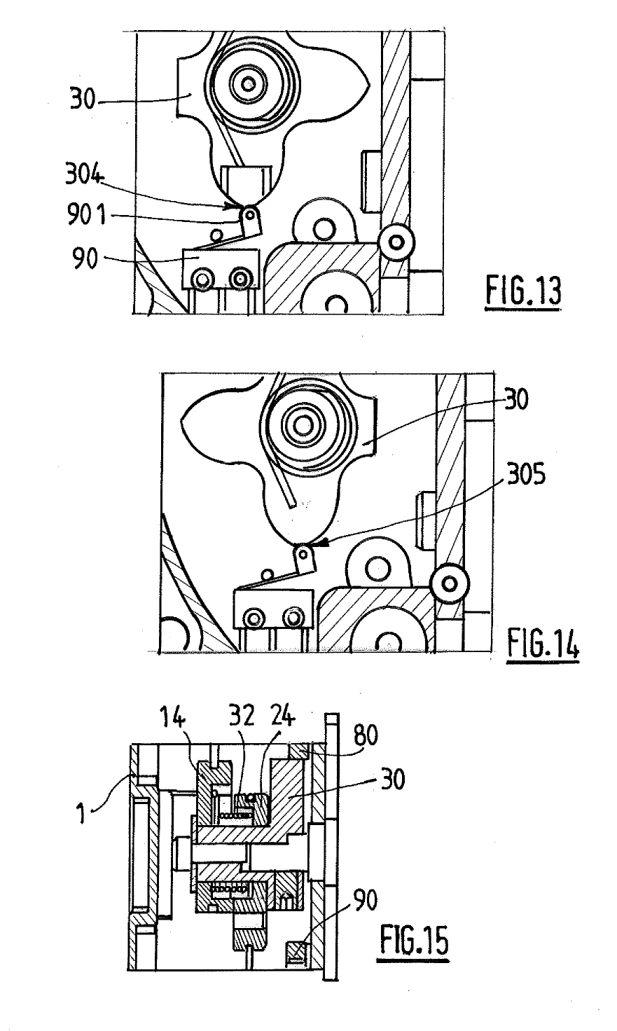

FIG. 13 is a view in detail of the embodiment of FIGS. 6 to 10 illustrating the control lever in the advanced position known as the “over travel” position on the side of the first cable,

FIG. 14 is a view in detail of the embodiment of FIGS. 6 to 10 illustrating the control lever in the advanced position known as the “over travel” position on the side of the second cable,

FIG. 15 is a view in section of a detail along the line CC of FIG. 9.

FIGS. 2 and 3 illustrate a non-limiting example of the control member 111 according to the invention. As shown in FIG. 1, the control member 111 may be used to control remotely the selective displacement of at least one and preferably two mobile actuators 140, 150. The actuators are located at the connecting ends 120, 130 of a system 100 for supplying fuel gas to one or more power-consuming members 110. The connecting ends are provided, for example, to accommodate, by connection, the respective tanks 300 of pressurized gas, each equipped with an isolating valve 210. In other words, the control member 111 selectively controls the movement of the actuator(s) 140, 150. The movement (the position) of the actuators 140, 150 opens up or allows the valve 210 of the tanks to be closed. For example, the actuator 140, 150 is a push valve and the isolating valve 210 is of the automatic closure-type valve.

FIG. 4 illustrates an example of a tank 300 for pressurized gas provided with a gas distribution device 200 (a tap, for example) housing the isolating valve 210. The gas distribution device 200 is, for example, (but not necessarily) of the type of that disclosed in the application WO2007/048956A.

FIG. 5 illustrates a possible connection example. Two tanks of this type are received in respective sleeves 500 and the respective gas distribution devices 200 are connected to the ends 400 of a gas supply system. In other words, the ends 400 of the sleeves 500 each comprise an actuator for controlling the opening of the isolating valve of the tank 300. The mobile actuators are selectively displaced by the control member 111.

The control member 111 comprises, for example, a body 1 of which one of the faces 2 (see FIG. 3) guides two movement transmission cables 11, 21. The cables 11, 21 are able to slide in respective sheaths 10, 20. The housing 1 preferably comprises mechanisms 101, 201 (see FIG. 2) for adjusting the length of the sheath 10, 20. The two cables 11, 21 are provided to connect the control member 111 mechanically to the mobile actuators 140, 150 of the ends 400 receiving the tanks (see FIGS. 1 and 5).

One face of the housing 1 may be provided to receive a motor 3, such as a geared motor designed to produce selectively a tractive force on the cables 11, 21 (for example, via a rotating shaft).

The tractive movements of the cable(s) 11, 21 provide remotely the displacement of the actuators 140, 150 and thus the selective opening of one or more isolating valves 210 of the tanks 300. When one or more isolating valves 210 are open, the gas may leave the tank and may be admitted to circulate in the system 100.

FIG. 6 illustrates a possible example of the internal mechanism of the control member 111. The two mechanical cables 11, 21 pass into respective sheaths 10, 20 and are then guided in the body 1 by respective pulleys 12, 22. The pulleys 12, 22 have their respective pivot shafts 13, 23 mounted on the body 1.

Each cable 11, 21 may then be wound about one respective control cam 14, 24 (the control cam may also be called a “spreader”) Each cable 11, 21 is fixed to its respective control cam 14, 24, via for example a crimped cable end 112, 212. Each crimped cable end 111, 211 may be captured in one respective bore 141, 241 provided in the corresponding control cam 14, 24.

The tractive force on the cables 11, 21 is transmitted to the control cams 14, 24 via a control lever 30 which is fixed in rotation to the rotational shaft of a geared motor 3.

When the two cables 11, 21 are not pulled relative to a stable resting position, the two control cams 14, 24 are in contact on an arm 302 of the lever. The resting position of the cables 11, 21 corresponds, for example, to a position of the actuator(s) 140, 150 not opening the isolating valves 210.

In this manner, activating the geared motor 3 in one direction (rotation of the shaft) makes it possible to exert a tractive force on the first cable 11. The activation of the geared motor 3 in the other direction (rotation of the shaft in the other direction) makes it possible to exert a tractive force on the second cable 21.

A retaining flap 50, 150 is associated with each cable 11, 21. A first end of each retaining flap 50, 150 is mounted in an articulated manner about a fixed shaft 59, 159. The second end of each retaining flap 50, 150 is fixed to its cable 11, 21 via a device for compensating for the compression of the sheath 10, 20 as disclosed below.

The transmission of a force onto the cable 11, 21 makes it possible to pivot the retaining flap 50, 150 which is associated therewith about its shaft 59, 159.

Each device for compensating for the compression of the sheath 10, 20 comprises a limiter 41 which is perforated longitudinally and in which the cable passes 11, 21. The limiter 41 is fixed to the cable 11, 21, for example by tightening two locking screws 45 and 46.

Each compensation device also comprises a limiter support 43 receiving the limiter 41. The limiter support 43 permits the translation of the limiter 41 inside said limiter support 43. A compression spring 42 bears between, on the one hand, an internal shoulder of the limiter support 43 and, on the other hand, an external shoulder of the limiter 41.

In the configuration of FIG. 6, the compensation device is at rest. In other words, the limiter 41 is in abutment on the limiter support 43. This abutment is implemented by a circlip 44 held on the limiter 41 (for example in a groove of the limiter 41). In this resting position, the circlip 44 is in abutment against one face 431 of the limiter support 43. A pole plate 51 is fixed to each flap 50, 150 (for example via a nut 54 and bolt 52 system).

Preferably, the bolt 52 for fixing each plate 51 comprises a spherical face bearing onto a chamfered face of said plate 51.

In this manner, a slight clearance (preferably a ball joint) is possible between the plate 51 and its flap 50, 150. The axial clearances between the parts may be compensated by the presence of a Belleville type spring washer 53 arranged between the pole plate 51 and its flap 50, 150.

The coupling between the device for limiting compression of the sheath and the corresponding flap 50, 150, is thus similar to a hinge. This coupling may, however, both be pivoted and translated (device for limiting compression of the sheath relative to the corresponding flap 50, 150).

The limiter support 43 carries a protruding shaft 432 received in an oblong bore 501 located at one mobile end of the flap 50, 150.

The member comprises two electromagnetic suction elements 60, 70 (of the electromagnet type) designed to cooperate respectively with the plates 51. The plates 51 are preferably metal or at least made of a material compatible with the suction elements 60, 70 from the electromagnetic point of view.

In the configuration of FIG. 6, the plates 51 and the flaps 50, 150 have been moved away from the respective electromagnetic suction elements 60, 70.

In FIG. 7 the first cable 11 is pulled into the active position. The device for compensating for compression of the sheath is active.

This configuration is the first phase in the operation of the control member 111. In this first phase, the control member 111 displaces a first actuator 140 to open an isolating valve 210 towards a gas distribution system.

The control lever 30 is rotated, for example, in the trigonometric (anti-clockwise) direction and exerts a torque transmitted to the control cam 14 of the first cable 11 (via, for example, an arm 301 of the lever 30).

This force causes the cable 11 to be wound about the control cam 14. This winding causes the translation of the cable 11 towards the inside of the body 1.

This makes it possible to place the retaining flap 51 in planar contact 601 with the electromagnetic suction element 60.

When the electrical current at the terminals of the geared motor 3 exceeds a predetermined threshold, the geared motor 3 is stopped (by an electronic logic unit). More specifically, the value of the strength of this current is dependent on the resistant forces overcome by the geared motor 3. This makes it possible to determine the moment when the mobile parts come into abutment in the system. This predetermined threshold is preferably slightly greater than the real requirement of the system in order to guarantee optimal operation of the mechanism. It is thus preferable to use a device for compensating for the compression of the sheath.

As a result of the resilient connection between the limiter 41 and the limiter support 43 due to the presence of the limiter spring 42, the limiter 41 may move in translation inside the limiter support 43. This translation compensates, therefore, for the excessive path of the cable 11 generated by possible compression of the sheath 10.

This makes it possible to avoid the transmission of excessive forces in the region of the retaining flap 51 when said retaining flap is in contact with the electromagnetic suction element 60. This also prevents the accumulation of parasitic forces on the cable 11. More specifically, these parasitic forces impair the stability for retaining the tension on the cable 11 provided by the electromagnetic suction element 60.

The electromagnetic suction element 60 is designed to have an electrical consumption which is as economical as possible when it is activated (subjected to current). It is thus activated when the threshold of the current of the geared motor 3 is exceeded and takes over from the geared motor 3 to retain the cable 11 in the active position.

In FIG. 8, the first cable 11 is in the active position, the control lever 30 is brought back into the neutral position (i.e. its initial position before the traction of the cable 11). The second cable 21 is in the resting position.

This operating phase represents the transition in which the tension of the cable 11, once it has been generated by the geared motor 3, is then retained solely by the electromagnetic suction element 60. In other words, the geared motor 3 is stopped and returns to its initial neutral position whilst the electromagnetic suction element 60 is subjected to current.

The control lever 30 is brought back to its initial (neutral) position, thus releasing the control cam 14. In this manner, the compensator for the compression of the sheath is released and returns to its resting position. The presence of a return spring 32 located in the control cams 14, 24 makes it possible to push back permanently the cams 14, 24 onto their associated cable 11, 21. This makes it possible to avoid any jamming of the system by the application of slight tension on the cables 11, 21 when the control lever 30 is no longer in contact with the control cams 14, 24 (see FIG. 15).

The tension of the cable 11 is thus transferred from the control cam 14 to the retaining flap 51. The flap 51 is blocked by the electromagnetic force generated by the electromagnetic suction element 60 when it is subjected to current.

To return to its neutral position, the geared motor 3 has to be activated in the reverse direction (clockwise), for example until it is detected (see FIG. 12) by a switch 80 (micro-switch, in particular). For example, the switch 80 indicates the neutral position to an electronic control unit by detecting the contact with a projection or cam 303 formed on the control lever 30 (see FIG. 11).

The activation of the switch 80 thus controls the stoppage of the electrical supply. This interrupts the existing contact between the control lever 30 and the control cam 14. This automatic procedure for returning the control lever 30 into the neutral position is provided to eliminate the forces associated with the resistant torque generated by the geared motor 3.

This automatic return of the control lever 30 into the neutral position permits an automatic closure of the gas distribution system in the event, for example, of the power supply to the electromagnetic suction element 60 being cut or generally the power supply to the application being cut. Thus, in the event of an interruption to the power supply, the cables 11, 21 automatically return to their resting position.

This function of automatic closure may be promoted by return springs present in the assembly of the mechanism of the end 400 of the gas system and/or in the distribution system 200. This return to the resting position does not require the addition of external energy (electrical energy, for example) and thus makes it possible to provide the closure of the gas distribution system of the canisters in all cases of malfunction. The system is said to be monostable and normally closed.

In FIG. 9, the first cable 11 and the second cable 21 are in the active position. The compensator for compression of the sheath of the second cable 21 is active (control lever 30 rotated relative to its neutral position).

In FIG. 10, the first cable 11 and the second cable 21 are in the active position. The compensator for compression of the sheath of the second cable is in the neutral position (control lever 30 returned to its neutral position). The operation disclosed above for the first cable 11 is identical and symmetrical to that of the second cable 21 of FIGS. 9 and 10. For this reason, the process will not be described in detail a second time.

Preferably, the second cable 21 may actuated (pulled) irrespective of the state of the first cable 11 and vice-versa. More specifically, although the control member 111 preferably only has a single geared motor 3 said geared motor may independently actuate one or other of the cables or arrange them both in the active position.

In this manner, it is possible, for example, to add the gas flows from two tanks into the supply system 100 by opening the two isolating valves 210 almost simultaneously. Similarly, it is possible to create an opening known as the intersection of the isolating valves 210, for example to preserve a constant flow of gas during the phase of exchange between the two tanks 300 (feed passage from a tank which is being emptied to a full tank).

FIGS. 13 and 14 illustrate a detailed view of the control member in the region of the control lever 30.

In FIG. 13, the lever is in the advanced or “over travel” position for the second cable 21. In FIG. 14, the lever 30 is in an advanced or “over travel” position for the first cable 11.

This device makes it possible to determine possible malfunction of the control member when the lever control 30 exceeds a critical operating angle. This exceeding of the limit angle occurs, for example, in the case of rupture or loose adjustment of the cables 11, 21. This state of malfunction is determined, for example, by the presence of a switch (90) (a micro-switch, in particular) when one of the projections 304, 305 of the control lever 30 encounters a contact roller 901 of the switch 90. When activated, the switch 90 cuts off the electrical supply to the geared motor 3.

This function makes it possible both to inform the control electronics system about a possible incident during activation of one of the two cables. This function also makes it possible to preserve the mechanical integrity of the system. This protects against any damage of the constituent elements of the control member in the case of excessive rotation of the control lever 30.

Naturally, the invention is not limited to the above example and all or some of the elements may be modified or combined in different ways.

1-15. (canceled)

16. A fuel gas supply system for a power-consuming member (110), in particular a gaseous hydrogen supply system (100) for a fuel cell (110) or a heat engine, the system (100) comprising
a) at least one upstream end (120, 130) comprising a movable mechanical actuator (140, 150) designed for selectively controlling the opening of an isolating valve (210) of a pressurized fuel gas tank (300) designed to be coupled to the upstream end (120, 130),
b) a control member (111) for controlling the displacement of the mechanical actuator (140, 150), the control member (111) being mechanically connected to the movable mechanical actuator (140, 150) via a selectively mobile mechanical movement transmission member (11, 21),
I) the control member (111) being offset relative to the actuator (140, 150) so as to provide remotely the displacement of the actuator (140, 150) via mechanical forces,
II) the movement transmission member (11, 21) comprising
a flexible cable and a displacement mechanism (3, 60, 70) for selective displacement of the cable (11, 21), the displacement mechanism (3, 60, 70) providing selective traction of the cable (11, 21) to a mechanically unstable active position relative to a specific mechanically stable resting position,
configured in its active position, the cable (11, 21) arranging the actuator (140, 150) in a position controlling the opening of an isolating valve (210),
wherein the displacement mechanism is electrically controlled and comprises an electric motor (3) such as a geared motor providing selective traction of the cable (11, 21) to the active position,
the displacement mechanism further comprising
a device (60, 50, 71) powered electrically for selectively retaining the cable (11, 21) in the active position, and
a commutator for deactivating the electrical supply to the electric motor (3) to the benefit of the retaining device (60, 70, 51) when the cable or the rod (11, 21) arrives in the active position.

17. The system of claim 16, wherein the cable (11, 21) is configured to be urged by default into its resting position by at least one of a return member or mechanical inertia.

18. The system of claim 16, wherein the power or the electrical consumption of the retaining device (60, 70, 51) is respectively less than the power or the electrical consumption of the electric motor (3).

19. The system of claim 16, wherein the cable (11, 21) is adapted to remain in its stable resting position or is displaced automatically into its stable resting position in the event of failure of the electrical supply to the displacement mechanism.

20. The system of claim 16, wherein the control member (111) is configured to be permanently supplied with electrical energy when the system is supplied with fuel gas from a pressurized gas tank connected to an upstream end (120, 130).

21. The system of claim 16, wherein the control member (111) is controlled by an electronic logic unit comprising an electronic board.

22. The system of claim 16, wherein each cable (11, 21) is associated with a tension limiter or displacement limiter to detect, via a switch or a sensor, an excessive displacement of a mobile part and adapted to control the stoppage of the motor in response to a detected excessive displacement.

23. The system of claim 16, wherein the electrically powered device for retaining a transmission member (11, 21) in the active position comprises a conductive part (51) fixed to the transmission member (11, 21) and an electromagnet (60, 70) or an electromagnetic suction element of which the electrical supply selectively causes the fixing of the conductive part (31) to the fixed electromagnet.

24. The system of claim 23, wherein the electromagnet (60, 70) or the electromagnetic suction element is powered electrically when a specific threshold of electrical current at the terminals of the geared motor is exceeded due to commutation from being retained in the active position provided by the retaining device (60, 70, 51) in place of the electric motor (3).

25. The system of claim 16, wherein the electric motor (3) is adapted to be stopped when the electrical current at its terminals exceeds a predetermined threshold.

26. The system of claim 16, wherein the system comprises two separate upstream ends (120, 130) each comprising one respective mechanical actuator (140, 150) for opening an isolating valve (210) of one respective gas tank (300), the control member (111) controlling the displacement of the two actuators (140, 150) via the respective transmission members (11, 21).

27. The device of claim 26, wherein the displacements of the two movement transmission members (11, 21) are controlled by the same electric motor (3) and are respectively implemented by movements of the motor in opposing directions.

28. The device of claim 27, wherein the shaft of the motor (3) is adapted to be urged by default into its neutral position by at least one return member or mechanical inertia when it is not subjected to current.

29. The system of claim 26, wherein the displacement mechanism comprises a single electric motor (3), configured to selectively provide traction of the respective transmission members (11, 21) to control the actuators (140, 150) so as to open independently the two valves (210) (sequentially or simultaneously), the displacement mechanism also comprising two electrical or electromagnetic retaining devices (60, 70, 51) respectively associated with the two transmission members (11, 21), the displacement mechanism also comprising one or more commutators to deactivate the power supply to the electric motor (3) to the benefit of one or more retaining devices (60, 70, 51) in order to retain the transmission member(s) (11, 21) in the active position.

30. A member for remotely controlling the displacement of one or two mechanical actuators (140, 150), comprising
a) an electrically controlled displacement mechanism (3), and
b) one respective movement transmission member (11, 21) associated with each actuator (140, 150), each transmission member (11, 21) having
I) a first end connected to the displacement mechanism (3) and
II) a second end designed to be mechanically connected to one respective mechanical actuator (140, 150) for its displacement, and
III) a flexible cable,
c) the displacement mechanism (3) being designed to provide selective traction of the transmission member(s) (11, 21) into a mechanically unstable active position relative to a specific mechanically stable resting position,
d) each of the transmission members (11, 21) adapted to be urged by default into its resting position,
e) the displacement mechanism further comprising an electrically controlled device (60, 70, 51) for retaining transmission members (11, 21) in the active position,
f) the displacement mechanism further comprising a commutator configured for deactivating the power supply to the electrically controlled displacement mechanism (3) to the benefit of the retaining device(s) (60, 70, 51), to retain the transmission member(s) (11, 21) in the active position.
